(19) United States
(12) Patent Application Publication
(10) Pub. No.: US 2018/0215858 A1
(43) Pub. Date: Aug. 2, 2018

(54) FIRE-RESISTANT POLYURETHANE COMPOUND COMPRISING PHOSPHOROUS-CONTAINING OLIGOMER ELEMENTS OF A CONTROLLED LENGTH

(71) Applicants: UNIVERSITE DU MAINE, Le Mans (FR); CENTRE NATIONAL DE LA RECHERCHE SCIENTIFIQUE - CNRS, Paris (FR)

(72) Inventors: Jean-François PILARD, Pance (FR); Arnaud NOURRY, La Bazoge (FR); Krishna Veni BARATHA NESAN, Selangor (MY)

(21) Appl. No.: 15/745,628

(22) PCT Filed: Jul. 13, 2016
(86) PCT No.: PCT/FR2016/051812

§ 371 Date: Jan. 17, 2018

(30) Foreign Application Priority Data
Jul. 17, 2015 (FR) 1501521

(51) Int. Cl. C08G 18/40; C08G 18/69; C08G 18/62; C09K 21/14

(52) U.S. Cl. CPC C08G 18/4063; C09K 21/14; C08G 18/6291; C08G 18/69

(57) ABSTRACT

Some embodiments are directed to a fire-resistant polyurethane material including a plurality of polyol reactive elements and a plurality of diisocyanate reactive elements and at least one diamine or diol reactive element operating as a chain extender of the polyurethane. A chain extender of at least the polyurethane material includes a phosphorous-containing oligomer element of a predefined length having a value within a dispersion interval, which is also predefined. Some embodiments also relate to polyurethanes obtained by implementing the method.

### CROSS REFERENCE TO RELATED APPLICATIONS

This application is a national phase filing under 35 C.F.R. § 371 of and claims priority to PCT Patent Application No. PCT/FR2016/051812, filed on Jul. 13, 2016, which claims the priority benefit under 35 U.S.C. § 119 of French Patent Application No. 1501521, filed on Jul. 17, 2015, the contents of each of which are hereby incorporated in their entireties by reference.

### BACKGROUND

Some embodiments relate to the field of polymers, and relate more particularly to polyurethanes that have fire-resistant properties.

Polyurethanes are mostly obtained via an exothermic reaction between a diisocyanate and a polyol. These products most often come from the petrochemical industry, which leads to a dependency on access to oil and to the costs that are associated with it.

Although the synthesis of polyurethanes is generally carried out using petrochemical derivatives, it is however possible using biosourced polyols in particular coming from natural rubber. In this latter case, the materials have specific properties (breaking elongation, compression, etc.)

Polyurethane materials including phosphorus can be used in various applications, such as, for example, for uses that implement their adhesive or fire-resistant properties.

It is then interesting to be able to manufacture polyurethanes that include phosphorus in order to have fire-resistant materials made from biosourced elastomers such as natural rubber, for example.

Compounds that contain halogens dominate the markets of fire-resistant materials, for reasons of cost. However directives in terms of respect for the environment exist and aim to reduce the use of these compounds.

In this context, compounds with a phosphorus base appear to be an interesting alternative to halogen-containing compounds, as a fire-resistant agent.

The incorporation of compounds with a phosphorus base can take place in different ways. There are in particular two main methods respectively referred to as the additive method and the reactive method. The additive method consists in mixing the phosphorous-containing compounds with a polymer without establishing covalent bonds between these two elements. This first method results in a material that can release phosphorous-containing compounds resulting in a progressive decrease in the fire-resistant properties at the same time as a potential toxicity.

The second method, reactive, allows for the establishing of covalent bonds between the host polymer and the phosphorous-containing compound, which prevents the previously-described release of phosphorous-containing compounds and furthermore makes it possible to reduce the mass percentage of phosphorous-containing compound in the polymer.

### SUMMARY

The related art techniques of insertion of phosphorous-containing compounds into a polyurethane describe the addition of phosphorous-containing molecules on chain extending elements of the polyurethane or on a carbon skeleton of the segments of the polyurethane.

Increasing the fire-resisting capacities of a polyurethane entails increasing the quantity of phosphorous-containing compound in the material. The additive method makes it possible to add phosphorous-containing compounds, just as in the reactive method, but by being easier to implement. It does require however a higher quantity of phosphorous-containing compound in order to obtain fire-resisting properties that are identical to those obtained by using the reactive method. The additive method however results in a degradation of the mechanical properties of the material.

Some embodiments therefore address, improve, or solve at least one of the disadvantages of the related art, by providing a fire-resistant polyurethane material using a plurality of polyol reactive elements and a plurality of diisocyanate reactive elements and at least one diamine or diol reactive element operating as a chain extender of the polyurethane. The chain extender of the polyurethane material includes a phosphorous-containing oligomer element of a predefined length. The predefined length has a value within a dispersion interval which is also predefined.

According to an embodiment of the presently disclosed subject matter, the predefined length is determined by the molar mass of the phosphorous-containing oligomer.

Advantageously, the polyol reactant is obtained using natural rubber or recycled rubber. Alternatives of recycled rubber can be, for example, of the NBR type (Nitrile Butadiene Rubber), SBR type (Styrene Butadiene Rubber) or recycled elastomers. More generally any type of rubber with an elastomer structure that has unsaturations in its structural chain can be used.

According to an embodiment of the presently disclosed subject matter, the polyol reactive elements are hydroxy telechelic natural rubber (HTNR).

Advantageously, the phosphorous-containing oligomer element is a poly-phosphonate or a poly-phosphate synthesised by the implementation of a technique of radical polymerisation controlled by reversible addition-fragmentation chain transfer also referred to as the RAFT method.

According to an embodiment of the presently disclosed subject matter, the phosphorous-containing oligomer element has a number-average molar mass of a value between 1000 and 6000 grams per mole.

Advantageously, the predefined length of the phosphorous-containing oligomer element has a polydispersity index within an interval of values ranging from 1 to 1.1, with these extreme values being included in the interval.

Some embodiments are directed to a method for manufacturing the material described hereinabove, namely a method for manufacturing a polyurethane material, with this method including at least one step of mixing a plurality of polyol reactive elements and a plurality of diisocyanate reactive elements, with at least one diamine or diol reactive element operating as a chain extender of the polyurethane, and with a catalyst. The method includes synthesising the chain extender element. The chain extender element includes at the end of the synthesis a chain of phosphorous-containing oligomer elements of a predefined length. The predefined length has a value within a dispersion interval which is also predefined.

According to an embodiment of the presently disclosed subject matter, the dispersion interval is defined by a dispersion interval of the molar mass of the phosphorous-containing oligomer introduced into the material. Advantageously, the dispersion interval of the molar mass is between the values 1 and 1.1. These values are within the interval.

According to an embodiment of the presently disclosed subject matter, the chain of phosphorous-containing oligomers of a controlled length is obtained by the implementation of a technique of radical polymerisation controlled by reversible addition-fragmentation chain transfer also referred to as the RAFT method prior to the synthesis of the polyurethane.

### BRIEF DESCRIPTION OF THE FIGURES

The presently disclosed subject matter shall be better understood, and other particularities and advantages shall appear when reading the following description, with the description referring to the annexed drawings among which:

FIG. 1 shows a polyurethane structure according to related art, such as is well known to those of ordinary skill in the art.

FIG. 2 shows a polyurethane structure similar to that of FIG. 1 but further including a chain extender EXT, also according to related art.

FIG. 3 shows a structure of a polyurethane PU material according to a particular and non-limiting embodiment of the presently disclosed subject matter.

FIG. 4 is a diagram that shows the steps of the method according to a particular and non-limiting embodiment of the presently disclosed subject matter.

FIG. 5 shows a 2-acryloyloxyethyl diethyl phosphate (ADEP) monomer used for the method of synthesising a polyurethane according to a particular and non-limiting embodiment of the presently disclosed subject matter.

FIG. 6 shows a poly-ADEP used for the method of synthesising polyurethane produced according to a particular and non-limiting embodiment of the presently disclosed subject matter.

FIG. 7 shows the developed formula of a reactant of the synthesis of the polyurethane produced according to a particular and non-limiting embodiment of the presently disclosed subject matter, coming from a synthesis using natural rubber.

### DETAILED DESCRIPTION OF THE EMBODIMENTS

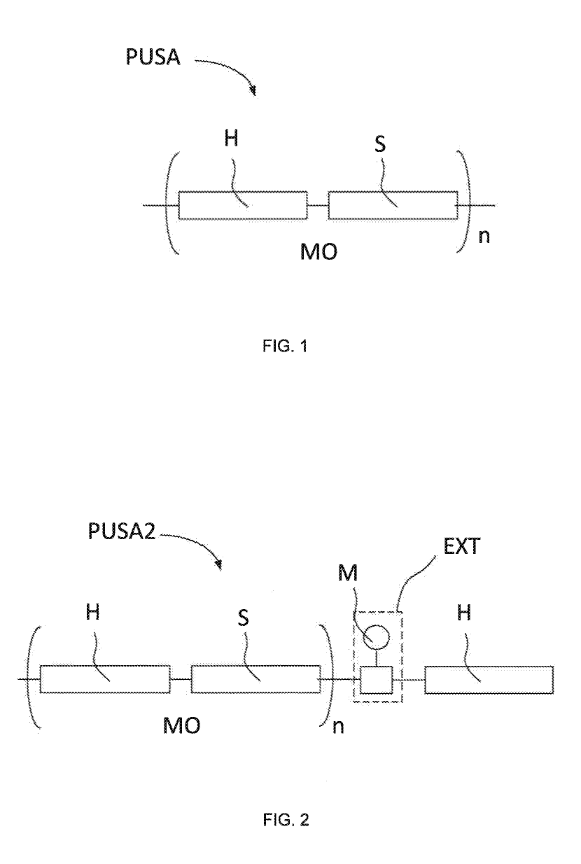

In FIGS. 1 to 7, the modules shown are functional units, which correspond or not to units that can be physically distinguished. For example, these modules or some of them are grouped together into a single component. On the contrary, according to other embodiments, certain modules are comprised of separated physical entities.

FIG. 1 shows a polyurethane structure according to the related art. The polyurethane material PUSA is comprised of a repetition of n monomers MO. Each one of the monomers MO includes a hard segment H and a soft segment S. The hard segment H is for example a diisocyanate and the soft segment S is for example a polyol.

FIG. 2 shows a polyurethane structure PUSA2 including a chain extender EXT, also according to related art. The hard segment H is for example a diisocyanate and the soft element S is for example a polyol. The chain extender EXT is a diol. The molecule M is, for example, a molecule of the carboxylic group type useful for producing coatings that make it possible to detect pathogenic bacteria.

The use of chain extenders of the EXT type allows in particular for the introduction of elements other than the monomers MO (S+H) mentioned hereinabove and therefore the adding of one or several new functionalities. Such a functionality can be, for example the introducing of a fire-resistant property to the polyurethane PUSA2. The chain extender EXT includes in the example described in this figure a molecule M which, according to its nature allows for the adding of a new property of the material PUSA2. By way of examples, this new property can be an anti-fouling property if M is a halogenated molecule of the chlorinated derivative type or a capacity for detecting pathogenic bacteria if M is a carboxylic group. The method for establishing (synthesis) the chemical bonds respectively present between the segments H and S and between these segments and the chain extender EXT are not discussed in any further detail here, as they are well known to those with ordinary skill in the art and are not needed to understand the presently disclosed subject matter.

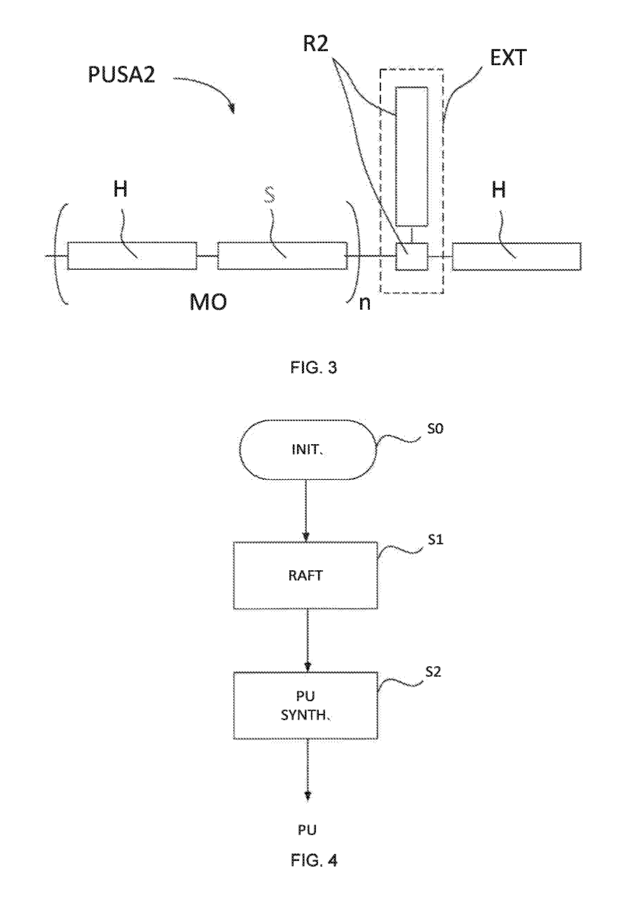

FIG. 3 shows a structure of a polyurethane PU according to a particular and non-limiting embodiment of the presently disclosed subject matter. The polyurethane PU includes a chain extender EXT. The chain extender EXT includes a chain R2 of phosphorous-containing oligomer elements of a predefined length L. This structure is obtained by implementing the method of manufacturing a polyurethane according to the presently disclosed subject matter. The term predefined length here means a length L being defined by a use of the RAFT polymerisation method. Indeed, the RAFT method targets a predefined molar mass, which corresponds to a number of repetitions of monomers (unit patterns), which consequently corresponds to an average chain length L of the oligomer manufactured, i.e. here a phosphorous-containing oligomer.

According to the preferred but not limiting embodiment of the presently disclosed subject matter, the polyurethane PU is synthesised in two main successive steps S1 and S2. A first synthesis S1 makes it possible to obtain the phosphorous-containing oligomer elements R2. A second synthesis S2, after the synthesis S1 corresponds to the final synthesis of the polyurethane PU.

Note that the phosphorous-containing oligomer R2 produced by the implementation of the synthesis carried out in the step S1 is used as a reactant element of the synthesis in the step S2.

The following paragraphs describe elements (constituents or reactants) according to a terminology that makes use of their denomination in English, in order to improve the readability of the method described, and with the purpose of respecting certain practices.

The synthesis of the phosphorous-containing oligomer R2 allows for the obtaining of the poly-ADEP (oligomer R2) such as shown in FIG. 6. The oligomer R2 is synthesised via the implementation of the RAFT method according to the protocol hereinafter:

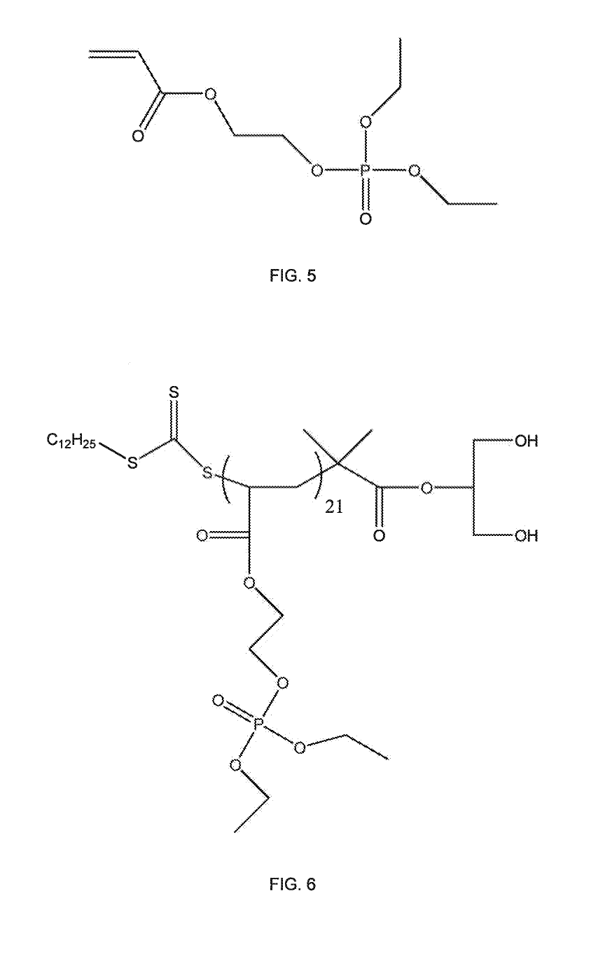

A 2-acryloyloxyethyl diethyl phosphate (ADEP) monomer is first synthesised according to a method that is well known to those with ordinary skill in the art. This monomer is shown in FIG. 5 in the developed formula thereof.

The implementing of the RAFT synthesis method uses as a RAFT agent 2-((1,3-dihydroxypropan-2-yloxy)carbonyl)propan-2-yl dodecylcarbonotrithioate. The latter is obtained by esterification of Steglish via the use of a coupling agent Dicyclohexylcarbodiimide (DCC) and the use of the catalyst 4-dimethylaminopyridine (DMAP).

For the purposes of obtaining the polymer poly-ADEP sought, the RAFT agent described hereinabove (1.00 g, 1.50 mmol), the monomer ADEP (9.45 g, 37.48 mmol), and the azobisisobutyronitrile (AIBN) (49.2 mg, 0.3 mmol) are introduced in the presence of toluene and of dimethylformamide (DMF) (0.1 mL) in a Shlenk under magnetic stirring and under argon, at 60° C., for 4 hours. The toluene and the DMF are then eliminated using a rotating evaporator under reduced pressure before the polymer is then purified by a series of precipitations in an ether/hexane mixture, filtered and dried in a vacuum oven at 40° C.

A hydroxy telechelic natural rubber (HTNR) coming from natural rubber is synthesised prior to the carrying out of the step S2 of the final synthesis of the polyurethane PU. This synthesis using the rubber is not discussed in any further detail here as it is not needed in itself to understand the method according to the presently disclosed subject matter.

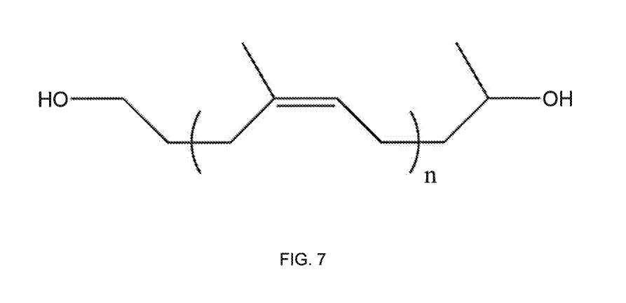

FIG. 7 shows the developed formula of hydroxy telechelic natural rubber (HTNR) coming from a synthesis using natural rubber.

In the step S2, a global (or final) synthesis of the polyurethane PU is carried out by the implementation of a method referred to as “one shot”. The hydroxy telechelic natural rubber HTNR (Mn=4058 g/mol, 14.25 g), the toluene diisocyanate (TDI) (0.74 g, 1.2 equivalent), the poly-ADEP (1% w/w) and the dibutyltin dilaurate catalyst (0.03% w/w) are introduced into a flat bottom flask and dissolved in tetrahydrofurane (THF) (30% w/v) and under magnetic stirring. This mixture is then poured into a 15*15 cm Teflon mould before being introduced into an oven at 40° C. for many hours (typically more than ten hours).

According to a first alternative of the embodiment, the monomer 2-acryloyloxyethyl diethyl phosphate (ADEP) used for the method of synthesising the polyurethane PU is replaced with a phosphonate monomer.

According to a second alternative of the embodiment, the poly-ADEP used for the method of synthesising the polyurethane PU is replaced with a phosphonate polymer Poly-DEAMP.

FIG. 4 is a macroscopic representation of the sequence S1, S2 of the steps of the method according to a particular and non-limiting embodiment of the presently disclosed subject matter. The step S0 is an initial step of preparing products useful in the synthesis of the polyurethane PU and includes in particular the phase of defining the average chain length R2 sought, which entails defining a target molar mass of the phosphorous-containing oligomer to be synthesised in the polyurethane PU. The step S1 consists in the implementing of the RAFT polymerisation method which will allow for the synthesis of the phosphorous-containing oligomer elements R2 (also called elements R2) that have for characteristics, among other things, a controlled average chain length that is directly according to the molar mass sought at the end of the RAFT method implemented. The step S2 consists of the polymerisation of the polyurethane PU via the reactive method, i.e. with the creation of covalent bonds between the various reactants.

In other terms and according to the embodiment described, the method according to the presently disclosed subject matter advantageously allows for the manufacturing of the polyurethane material PU using a plurality of polyol soft reactant elements S and a plurality of diisocyanate hard reactant elements H and at least one reactant element EXT, diamine or diol, operating as a chain extender of the polyurethane PU, in such a way that at least one chain extender EXT of the polyurethane PU obtained (manufactured) includes an element of the type of the phosphorous-containing oligomer R2 of predefined length L in a predefined dispersion interval DL. The predefined length L is determined by the number-average molar mass of the phosphorous-containing oligomer R2, as an input parameter of the RAFT synthesis method. The polyol soft reactant elements S are hydroxy telechelic natural rubber obtained using natural rubber. The phosphorous-containing oligomer element R2 is a poly-phosphonate or a poly-phosphate synthesised by the implementation of a technique of radical polymerisation controlled by reversible addition-fragmentation chain transfer RAFT. By way of example, its number-average molar mass has a value between 1000 and 6000 grams per mole. The method of manufacturing the polyurethane material PU according to the presently disclosed subject matter includes at least the step S2 of mixing polyol soft reactant elements S and diisocyanate hard reactant elements H, with the reactant diamine or diol EXT which operates as a chain extender of PU, and of a catalyst. The method also includes the step of synthesis S1, prior to S2, of the chain extender EXT which includes at the end of this synthesis S1 at least one chain R2 of phosphorous-containing oligomer elements of the length L defined hereinabove by the sought molar mass. The dispersion interval DL chain length of R2 is defined using the dispersion interval of the molar mass of R2. For example, the dispersion interval of the molar mass of R2 has a value greater than or equal to 1 and less than or equal to 1.1.

Advantageously, the method of manufacturing according to the presently disclosed subject matter allows for an optimisation of the quantity and of the distribution of the phosphorous-containing oligomer elements R2 in the polyurethane (PU) material produced as such.

More precisely, the ability to insert phosphorous-containing oligomer elements R2 via the synthesis of chains of a controlled average length L allows for an optimum distribution of these elements in the polyurethane PU material.

Experiments conducted in the laboratory have revealed the fact that the fire-resisting capacities of the material PU manufactured as such are increased for a given interval of chain length L of the phosphorous-containing oligomer R2.

The effectiveness in terms of the flame-retardant property of the material PU manufactured by the implementing of the method according to the presently disclosed subject matter, according to the average length L of the phosphorous-containing oligomer chains R2, and therefore of the target molar mass of R2 via the synthesis thereof by the RAFT synthesis method, can be represented by a curve in the shape of a bell. Indeed, when the length L of the phosphorous-containing oligomer chains R2 increases to a threshold value, the performance of the flame retardant of the material PU also increases up to a maximum. Then, when the length of the chains of R2 continues to increase beyond this threshold value, the performance of the flame retardant of the material PU decreases.

Thanks to the use of the method according to the presently disclosed subject matter, the fire-resisting capacities of the material PU produced as such (manufactured by implementing the method according to the presently disclosed subject matter) are increased for equivalent mechanical characteristics in relation to the materials available according to related art (i.e. obtained reactively with a molecule grafted onto a chain extender or a soft segment of a polyurethane).

The presently disclosed subject matter is not limited to only the embodiment described hereinabove but obviously relates to any polyurethane using a plurality of soft reactant elements, a plurality of hard reactant elements and at least one reactant element operating as a chain extender that uses the introduction of chain extenders for the insertion of elements of a phosphorous-containing oligomer of a predefined and controlled average length. The controlled chain length has a value within a dispersion interval which is also predefined.

1. A fire-resisting polyurethane (PU) material, comprising:
a plurality of polyol reactive elements (S) obtained using natural rubber or recycled rubber;
a plurality of diisocyanate reactive elements (H); and
at least one diamine or diol reactive element operating as a chain extender (EXT) of said polyurethane, the at least one chain extender (EXT) of the polyurethane material (PU) including a phosphorous-containing oligomer element (R2) of a predefined length (L), the length (L) having a value within a predefined dispersion interval.

2. The polyurethane (PU) material as claimed in claim 1, wherein the predefined length (L) is determined by the number-average molar mass of the phosphorous-containing oligomer (R2).

3. (canceled)

4. The polyurethane (PU) material as claimed in claim 1, wherein the polyol reactive elements (S) are hydroxy telechelic liquid rubbers having formula:

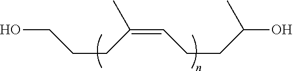

5. The polyurethane (PU) material as claimed in claim 1, wherein the phosphorous-containing oligomer element (R2) is a poly-phosphonate or a poly-phosphate synthesised by the implementation of a technique of radical polymerisation controlled by reversible addition-fragmentation chain transfer also referred to as the RAFT method.

6. The polyurethane (PU) material as claimed in claim 1, wherein the phosphorous-containing oligomer element (R2) has a number-average molar mass of a value between 1000 and 6000 grams per mole.

7. The polyurethane (PU) material as claimed in claim 1, wherein the predefined length (L) of said phosphorous-containing oligomer element (R2) has a predefined dispersion characteristic.

8. A method for manufacturing a polyurethane material, the method comprising:
mixing a plurality of polyol reactive elements (S) and a plurality of diisocyanate reactive elements (H), of at least one diamine or diol reactive element operating as a chain extender (EXT) of the polyurethane, and of a catalyst; and
synthesising (S1) the chain extender element (EXT) that includes at the end of said synthesis (S1) a chain (R2) of phosphorous-containing oligomer elements of predefined length (L), the predefined length (L) having a value within a predefined dispersion interval by a dispersion interval of the molar mass of said phosphorous-containing oligomer.

9. (canceled)

10. The method for manufacturing a polyurethane material as claimed in claim 8, wherein the dispersion interval of said molar mass is between the values 1 and 1.1 inclusive.

11. The method for manufacturing a polyurethane material as claimed in claim 8, wherein the chain of phosphorous-containing oligomers of a controlled length is obtained by the implementation of a technique of radical polymerisation controlled by reversible addition-fragmentation chain transfer also referred to as the RAFT method prior to said synthesis.

12. The polyurethane (PU) material according to claim 2, wherein the polyol reactant (S) is obtained using natural rubber or recycled rubber.

13. The polyurethane (PU) material as claimed in claim 2, wherein the polyol reactive elements (S) are hydroxy telechelic liquid rubbers having formula:

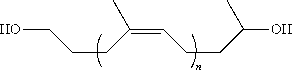

14. The polyurethane (PU) material as claimed in claim 3, wherein the polyol

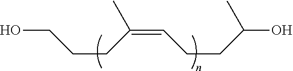

15. The polyurethane (PU) material as claimed in claim 2, wherein the phosphorous-containing oligomer element (R2) is a poly-phosphonate or a poly-phosphate synthesised by the implementation of a technique of radical polymerisation controlled by reversible addition-fragmentation chain transfer also referred to as the RAFT method.

16. The polyurethane (PU) material as claimed in claim 3, wherein the phosphorous-containing oligomer element (R2) is a poly-phosphonate or a poly-phosphate synthesised by the implementation of a technique of radical polymerisation controlled by reversible addition-fragmentation chain transfer also referred to as the RAFT method.

17. The polyurethane (PU) material as claimed in claim 4, wherein the phosphorous-containing oligomer element (R2) is a poly-phosphonate or a poly-phosphate synthesised by the implementation of a technique of radical polymerisation controlled by reversible addition-fragmentation chain transfer also referred to as the RAFT method.

18. The polyurethane (PU) material as claimed in claim 2, wherein the phosphorous-containing oligomer element (R2) has a number-average molar mass of a value between 1000 and 6000 grams per mole.

19. The polyurethane (PU) material as claimed in claim 3, wherein the phosphorous-containing oligomer element (R2) has a number-average molar mass of a value between 1000 and 6000 grams per mole.

20. The polyurethane (PU) material as claimed in claim 4, wherein the phosphorous-containing oligomer element (R2) has a number-average molar mass of a value between 1000 and 6000 grams per mole.
